(19) United States
(12) Patent Application Publication
(10) Pub. No.: US 2026/0248188 A1
(43) Pub. Date: Aug. 27, 2026

(54) HEATING PIECE AND HEATING ELEMENT FOR VAPORIZING CORE

(71) Applicant: HUIZHOU HAPPY VAPING TECHNOLOGY LIMITED, Huizhou, Guangdong (CN)

(72) Inventors: Guangrong Lin, Huizhou, Guangdong (CN); Xianbin Zheng, Huizhou, Guangdong (CN)

(21) Appl. No.: 18/992,574

(22) PCT Filed: Jul. 18, 2023
(86) PCT No.: PCT/CN2023/107967

§ 371 Date: Jan. 9, 2025

(30) Foreign Application Priority Data
Sep. 30, 2022 (CN) 202222633795.2

(51) Int. Cl. A24F 40/46; A24F 40/10

(52) U.S. Cl. CPC A24F 40/46; A24F 40/10

(57) ABSTRACT

A heating piece (1) and a heating element for vaporizing core is provided. The heating piece (1) for vaporizing core comprises a first electrode plate (11), a second electrode plate (12), and a heating mesh (2) connected between the first electrode plate (11) and the second electrode plate (12). The heating mesh (2) comprises at least two electrically conductive heating lines (21) longitudinally arranged in parallel, adjacent two of the electrically conductive heating lines (21) have axially symmetric meandering paths, a plurality of thermally conductive lines (22) are transversely connected between respective pairs of equipotentials on the adjacent two of the electrically conductive heating lines (21), so as to conduct and dissipate heat from the electrically conductive heating lines (21), the electrically conductive heating lines (21) and the thermally conductive lines (22) are connected to form substantially uniformly distributed mesh lines, and gaps are provided between the mesh lines.

### TECHNICAL FIELD

The disclosure relates to the technical field of vaporizing cores of electronic cigarette vaporizers, and more particularly, the disclosure relates to a heating piece and heating element for vaporizing core.

### BACKGROUND

An electronic cigarette in the market generally includes a battery part and a vaporizer, with a vaporizing core arranged inside the vaporizer. The vaporizing core includes a liquid-guiding element, and a heating element which heats and vaporizes a vaporizing liquid to produce aerosol when powered on. The vaporizing liquid, namely the e-cigarette liquid, is stored in the vaporizer of the electronic cigarette, and the produced aerosol is namely the e-cigarette vapor for users to inhale. Generally, the heating element is in contact with a surface of the liquid-guiding element to define a vaporizing surface at the contact position, where the e-cigarette vapor is generated and distributed.

The heating piece for vaporizing core currently available in the market typically has a structure with S-shaped single-path circuit. Such circuit structure which has single line-type cannot be widely applied on the vaporizing surface, thereby resulting in uneven heating, lower heat generation or vapor amount, inefficient vaporization and thus long response time during vaping, and poor vaporization effects. Furthermore, the area where heat is concentrated may overheat and produce a burnt taste.

### SUMMARY

### Technical Problems

An objective of the disclosure is to provide a heating piece and a heating element for vaporizing core, which has a heating mesh with substantially uniformly distributed mesh lines, to facilitate uniform heating to allow the heat to be quickly uniformly distributed across the entire heating mesh when energized to generate heat, and to facilitate quick and timely vaporization of the vaporizing liquid to achieve a large vapor amount and good vaporization effect.

### Technical Solutions

A technical solution of the disclosure is provided as follows. A heating piece for vaporizing core comprises a first electrode plate, a second electrode plate, and a heating mesh connected between the first electrode plate and the second electrode plate, wherein the heating mesh comprises at least two electrically conductive heating lines which are longitudinally arranged in parallel with each other, adjacent two of the electrically conductive heating lines have axially symmetric meandering paths, a plurality of thermally conductive lines are transversely connected between respective pairs of equipotentials on the adjacent two of the electrically conductive heating lines, the thermally conductive lines are configured to conduct and dissipate heat from the electrically conductive heating lines, the electrically conductive heating lines and the thermally conductive lines are connected to form substantially uniformly distributed mesh lines, and gaps are provided between the mesh lines.

Preferably, the electrically conductive heating lines and the thermally conductive lines may both consist of a plurality of straight-line segments which are connected in a zigzag manner.

Preferably, a transverse span width of the electrically conductive heating lines may be set to be 1.5 to 5 times a transverse straight-line spacing of the thermally conductive lines.

Preferably, path widths of the electrically conductive heating lines and the thermally conductive lines may be respectively set to 0.05 mm to 1.2 mm.

Preferably, a gap width of the mesh lines may be set to be 1 to 8 times a path width of the mesh lines.

Preferably, the electrically conductive heating lines and the thermally conductive lines may be integrally formed by same metallic material.

Preferably, two of the electrically conductive heating lines on outermost sides may be transversely connected with a plurality of anchor jaws for fixation on outer sides.

Preferably, tail ends of the anchor jaws may be bent and provided with prongs.

Preferably, the first electrode plate and the second electrode plate may be respectively bent into a Z shape, with a bottom portion of the Z shape serving as a power connecting portion.

Another technical solution of the disclosure is provided as follows. A heating element for vaporizing core comprises an insulator sheet centrally provided with a through-hole and the heating piece for vaporizing core according to any one of claims 1-9, wherein the heating piece for vaporizing core is fixedly arranged on the insulator sheet, the heating mesh of the heating piece for vaporizing core is exposed within the through-hole of the insulator sheet, and the first electrode plate and the second electrode plate are at least partially exposed to two ends of a bottom surface of the insulator sheet.

### Advantages

The heating piece and heating element for vaporizing core of the disclosure has advantages as follows. The heating piece and heating element for vaporizing core has a simple structure. The heating mesh is formed by the electrically conductive heating lines and the thermally conductive lines which are connected into substantially uniformly distributed mesh lines. When the electrically conductive heating lines are energized to generate heat, the heat can be quickly conducted and dissipated through the thermally conductive lines which are electrically non-conductive and located therebetween, and thus the heat can be distributed uniformly across the entire heating mesh, thereby achieving more uniform heating of the heating mesh. It can prevent burning taste caused by localized high-temperature overheating due to heat concentration and uneven vaporization. Moreover, as the entire heating mesh is heated simultaneously, a larger heating area can be provided, thereby facilitating quick and timely vaporization of the vaporizing liquid to achieve a large vapor amount, and greatly improving the vaporization effect.

### BRIEF DESCRIPTION OF THE DRAWINGS

FIG. 1 is a first perspective view of a heating piece for vaporizing core according to embodiment 1 of the disclosure;

FIG. 2 is a second perspective view of a heating piece for vaporizing core according to embodiment 1 of the disclosure;

FIG. 3 is a first perspective view of a heating piece for vaporizing core according to another embodiment of the disclosure;

FIG. 4 is a second perspective view of a heating piece for vaporizing core according to another embodiment of the disclosure;

FIG. 5 is a third perspective view of a heating piece for vaporizing core according to embodiment 1 of the disclosure;

FIG. 6 is an exploded perspective view of a heating element for vaporizing core according to embodiment 2 of the disclosure;

FIG. 7 is a front perspective view of a heating element for vaporizing core according to embodiment 2 of the disclosure;

FIG. 8 is a reversed perspective view of a heating element for vaporizing core according to embodiment 2 of the disclosure;

### PREFERRED EMBODIMENTS OF THE INVENTION

The heating piece for vaporizing core of the disclosure is for assembly to the vaporizing core of the electronic cigarette to heat and vaporize the e-cigarette liquid into aerosol or e-cigarette vapor.

### Embodiments of the Disclosure

The disclosure will be further explained in detail with reference to particular embodiments.

### Embodiment 1

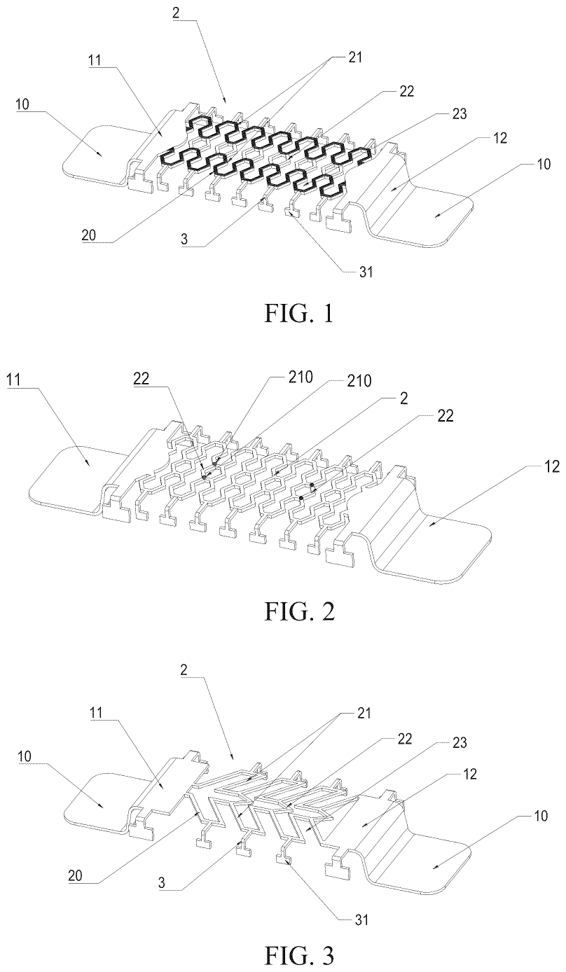

Referring to FIGS. 1-2, the heating piece for vaporizing core in the embodiment comprises a first electrode plate 11, a second electrode plate 12, and a heating mesh 2 connected between the first electrode plate 11 and the second electrode plate 12. The heating mesh 2 comprises two electrically conductive heating lines 21 which are longitudinally arranged in parallel with each other, and two ends of each of the electrically conductive heating lines 21 are connected with the first electrode plate 11 and the second electrode plate 12, respectively. The adjacent two electrically conductive heating lines 21 have axially symmetric meandering paths, and the meandering path of each of the electrically conductive heating lines 21 has a certain transverse span (indicated by the black bold lines as shown in FIG. 1). The electrically conductive heating lines 21 are made of a heating resistor material, particularly a thermosensitive heating resistor material. When power is applied to the first electrode plate 11 and the second electrode plate 12, the two electrically conductive heating lines 21 will be energized to generate heat, thereby heating the liquid-guiding element covering thereon and evaporating and atomizing the liquid, such as e-cigarette liquid, stored within the liquid-guiding element. In other embodiments, on the two electrically conductive heating lines 21 which are longitudinally arranged in parallel with each other and have adjacent conductive heating tracks, a pair of equipotentials 210 (indicated by the black dots as shown in FIG. 2) are formed at positions that are opposite each other and have the same voltage, and a thermally conductive line 22 is transversely provided and connected between the pair of equipotentials 210. Several thermally conductive lines 22 can be provided between several pairs of equipotentials 210, respectively. To achieve uniform arrangement, the thermally conductive line 22 may also have a meandering path. As the two ends of the thermally conductive line 22 are at the same potential, the thermally conductive line will not conduct electricity even when made of metallic materials. However, the thermally conductive line 22 can quickly conduct and dissipate heat from the electrically conductive heating lines 21. The electrically conductive heating lines 21 and the thermally conductive lines 22 are connected to form substantially uniformly distributed mesh lines, with gaps 23 provided between the lines of the mesh to allow the vapor fog generated by heating and vaporization to escape. In the embodiment, the electrically conductive heating lines 21 and the thermally conductive lines 22 both consist of several straight-line segments 20 connected in a zigzag manner, which is more conducive to uniform arrangement of the lines. The electrically conductive heating lines 21 and the thermally conductive lines 22 can be integrally formed and etched from the same metallic material, such as stainless steel. The heating resistor made of stainless steel has advantages of high temperature resistance and corrosion resistance.

In the embodiment, the two electrically conductive heating lines 21 are respectively transversely connected with several anchor jaws 3 for fixation laterally on their outer sides. The tail ends of the anchor jaws 3 are bent and provided with prongs 31. The anchor jaws 3 and their prongs 31 can be embedded in an insulating support or insulator sheet to fix the heating mesh 2 onto the insulating support or insulator sheet. The arrangement of several anchor jaws 3 contributes to allow the heating mesh 2 to be uniformly stressed, thereby reducing deformation and loosening in high-temperature environments. The anchor jaws 3 and their prongs 31 can be integrally formed with the heating mesh 2.

In the embodiment, the first electrode plate 11 and the second electrode plate 12 are respectively bent into a Z shape, with the bottom portion of the Z shape serving as the power connecting portion 10. Such configuration facilitates the arrangement of providing the heating mesh 2 on one side of the insulator sheet and meanwhile providing the power connecting portions 10 of the first electrode plate 11 and the second electrode plate 12 on the other side of the insulator sheet during manufacture of the heating element. Such arrangement is advantageous to place the liquid-guiding element on the insulator sheet and meanwhile allow the heating mesh to tightly abut against the bottom portion of the liquid-guiding element. The power connecting portions 10 of the first electrode plate 11 and the second electrode plate 12 are located underneath the insulator sheet, making it convenient for electrode columns to connect with and abut against the power connecting portions 10 of the first electrode plate 11 and the second electrode plate 12 from bottom to top. Thus, it is beneficial for mounting and automatic production.

In the embodiment, the electrically conductive heating lines 21 and the thermally conductive line 22 are connected to form substantially uniformly distributed mesh lines. The mesh lines may be designed in a pattern close to a honeycomb shape, with the lines being uniformly distributed. Experiments and tests have shown that, when the electrically conductive heating lines 21 are energized to generate heat, the heat can be quickly conducted and dissipated through the thermally conductive lines 22 which are electrically non-conductive and located therebetween, and thus the heat can be distributed uniformly across the entire heating mesh 2, thereby achieving uniform heating of the heating mesh 2. More than two electrically conductive heating lines 21 may be provided.

It can prevent burning taste caused by localized high-temperature overheating due to heat concentration and uneven vaporization. Moreover, as the entire heating mesh 2 is heated simultaneously, a larger heating area can be provided, thereby facilitating quick and timely vaporization of the vaporizing liquid to achieve a large vapor amount, and greatly improving the vaporization effect.

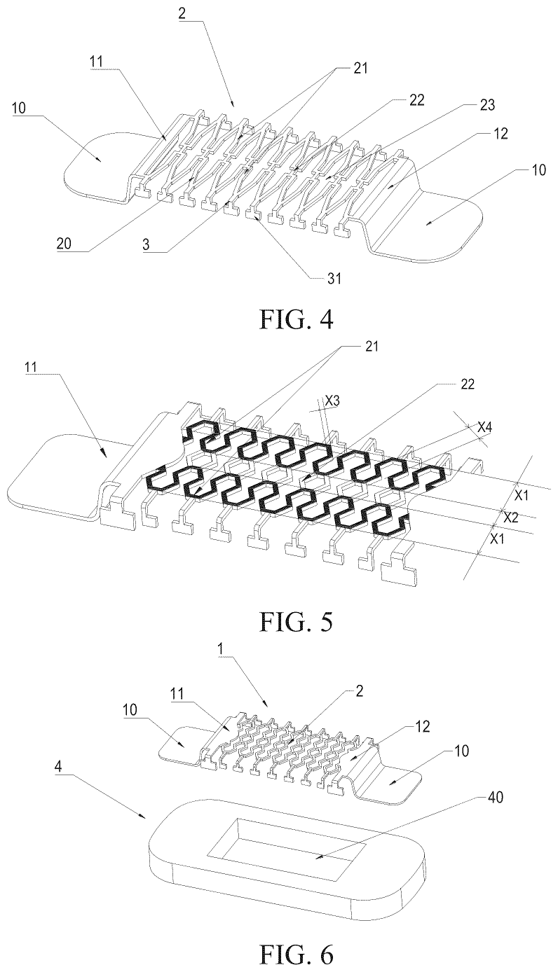

Referring to FIGS. 3-4, in other embodiments, the mesh lines may be designed in a pattern as shown in FIG. 3 or FIG. 4, to achieve quick generation and uniform distribution of the heat.

Referring to FIG. 5, in the embodiment, in order to facilitate quick distribution of the heat generated by the electrically conductive heating lines 21 across the entire heating mesh, the electrically conductive heating lines 21 and the thermally conductive lines 22 may be specially designed in terms of the size or position distance. Such design includes setting the transverse span width X1 of the electrically conductive heating lines 21 to be 1.5 times the transverse straight-line spacing X2 of the thermally conductive lines 22, wherein the transverse straight-line spacing X2 of the thermally conductive lines 22 is namely the straight-line distance between two ends of the thermally conductive lines 22. In other embodiments, the transverse span width X1 of the electrically conductive heating lines 21 may be set to be 1.5 to 5 times, preferably 1.5 to 2.5 times, the transverse straight-line spacing X2 of the thermally conductive lines 22. The transverse straight-line spacing X2 of the thermally conductive lines 22 may be set to be smaller than the transverse span width X1 of the electrically conductive heating lines 21 in a certain proportion, to make it possible for the electrically conductive heating lines 21 to generate more heat. Meanwhile, as the thermally conductive lines 22 have small transverse straight-line spacing, the heat of the electrically conductive heating lines 21 can be absorbed and conducted more quickly when the thermally conductive lines 22 do not generate heat by themselves.

The path width X3 of the electrically conductive heating lines 21 and the thermally conductive lines 22 may both be set to 0.1 mm. Such dimensions enable the electrically conductive heating lines 21 to have a higher heating resistance, to facilitate quick heating. In other embodiments, the path width X3 of the electrically conductive heating lines 21 and the thermally conductive lines 22 may be respectively set to 0.05 mm to 1.2 mm, preferably 0.1 mm to 0.5 mm.

In the embodiment, a gap width X4 of the mesh lines may be set to be 1 to 8 times, preferably 2 to 4 times, the path width X3 of the mesh lines, namely the electrically conductive heating lines 21 and the thermally conductive lines 22.

### Embodiment 2

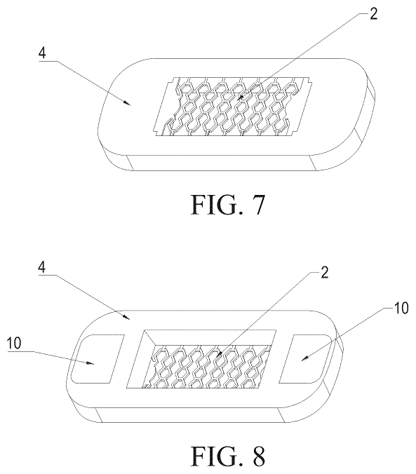

Referring to FIGS. 6-8, the heating element for vaporizing core in the embodiment includes the heating piece for vaporizing core 1 as described in Embodiment 1, as well as an insulator sheet 4 which is centrally provided with a through-hole 40. The insulator sheet 4, which serves to support and fix the heating piece 1, has heat-resistant and insulating properties, and the top surface of the insulator sheet 4 can be used to support the liquid-guiding element.

The heating piece for vaporizing core 1 is fixedly arranged on the insulator sheet 4. In particular, the heating piece for vaporizing core 1 and the insulator sheet 4 may be integrally manufactured, with the heating piece for vaporizing core 1 being embedded in the insulator sheet 4. The heating mesh 2 of the heating piece for vaporizing core 1 is exposed within the through-hole 40 of the insulator sheet 4 and located on the upper plane surface of the insulator sheet 4, which allows the heating mesh 2 to get close to the vaporizing surface at the lower surface of the liquid-guiding element, so as to heat and vaporize the vaporizing liquid in the liquid-guiding element into vapor or aerosol when energized to generate heat. Then, the vapor can be released through the gaps 23.

The power connecting portions 10 of the first electrode plate 11 and the second electrode plate 12 of the heating piece for vaporizing core 1 are exposed to two ends of the bottom surface of the insulator sheet 4. Such design makes it convenient for electrode columns connected with external power supply to connect with and abut against the power connecting portions 10 of the first electrode plate 11 and the second electrode plate 12 from bottom to top, which is beneficial for mounting and automatic production.

### Industrial Applicability

All the above are merely preferred embodiments of the disclosure. The present invention is intended to cover all equivalent arrangements and modifications derived from the claims of the present invention.

1. A heating piece for vaporizing core, characterized in that, the heating piece comprises a first electrode plate, a second electrode plate, and a heating mesh connected between the first electrode plate and the second electrode plate, the heating mesh comprises at least two electrically conductive heating lines which are longitudinally arranged in parallel with each other, adjacent two of the electrically conductive heating lines have axially symmetric meandering paths, a plurality of thermally conductive lines are transversely connected between respective pairs of equipotentials on the adjacent two of the electrically conductive heating lines, the thermally conductive lines are configured to conduct and dissipate heat from the electrically conductive heating lines, the electrically conductive heating lines and the thermally conductive lines are connected to form substantially uniformly distributed mesh lines, and gaps are provided between the mesh lines.

2. The heating piece for vaporizing core according to claim 1, wherein the electrically conductive heating lines and the thermally conductive lines both consist of a plurality of straight-line segments which are connected in a zigzag manner.

3. The heating piece for vaporizing core according to claim 1, wherein a transverse span width of the electrically conductive heating lines is set to be 1.5 to 5 times a transverse straight-line spacing of the thermally conductive lines.

4. The heating piece for vaporizing core according to claim 1, wherein path widths of the electrically conductive heating lines and the thermally conductive lines are respectively set to 0.05 mm to 1.2 mm.

5. The heating piece for vaporizing core according to claim 1, wherein a gap width of the mesh lines is set to be 1 to 8 times a path width of the mesh lines.

6. The heating piece for vaporizing core according to claim 1, wherein the electrically conductive heating lines and the thermally conductive lines are integrally formed by same metallic material.

7. The heating piece for vaporizing core according to claim 1, wherein two of the electrically conductive heating lines on outermost sides are transversely connected with a plurality of anchor jaws for fixation on outer sides.

8. The heating piece for vaporizing core according to claim 7, wherein tail ends of the anchor jaws are bent and provided with prongs.

9. The heating piece for vaporizing core according to claim 1, wherein the first electrode plate and the second electrode plate are respectively bent into a Z shape, with a bottom portion of the Z shape serving as a power connecting portion.

10. A heating element for vaporizing core, characterized in that, the heating element comprises an insulator sheet centrally provided with a through-hole and the heating piece for vaporizing core according to claim 1, wherein the heating piece for vaporizing core is fixedly arranged on the insulator sheet, the heating mesh of the heating piece for vaporizing core is exposed within the through-hole of the insulator sheet, and the first electrode plate and the second electrode plate are at least partially exposed to two ends of a bottom surface of the insulator sheet.
